(19) United States
(12) Patent Application Publication
(10) Pub. No.: US 2005/0278219 A1
(43) Pub. Date: Dec. 15, 2005

(54) Methods and systems for marketing indoor advertising

(76) Inventor: Aaron Zeitner, Chicago, IL (US)

Correspondence Address: HOVEY WILLIAMS LLP, Suite 400, 2405 Grand Blvd., Kansas City, MO, 64108-2519, US

(21) Appl. No.: 10/867,559

(22) Filed: Jun. 14, 2004

(51) Int. Cl. G06F 17/60

(52) U.S. Cl. 705/14

(57) ABSTRACT

Advertising marketing methods and systems are disclosed, whereby the provision of advertising content and optional advertising success correlation data is marketed to exhibitors who are exhibiting and targeting attendees at an arbitrary event.

### DESCRIPTION OF THE INVENTION

1. Field

The present teaching relates to methods and systems for providing indoor advertising, and more particularly to marketing indoor restroom advertising to exhibitors or sponsors, i.e. event participants, in connection with scheduled events, such as, for example conventions.

2. Introduction

Indoor advertising, such as restroom advertising is a popular advertising medium that has been deployed in settings such as bars, restaurants, nightclubs, arenas, convention centers and exhibition halls.

The conventional business model for marketing and providing indoor advertising consists of placing a frame or a device, which secures advertisements to defined areas to hold advertising messages and print ads of various sizes, in direct view of a person while the person is using the restroom facilities. This type of advertising has been slowly gaining recognition by consumers of advertising services, for the outstanding retention and due to other advantages, compared to other advertising media.

However, advertising companies that currently operate in the indoor restroom advertising industry are mostly unfocused and aimed at local and national advertisers seeking relatively inexpensive advertising. The goal of the indoor advertising marketer is to drive business from the amount of male/female target demographic, which is typically achieved by retention of the advertisement by viewers of the advertisement rather than on a highly focused target audience.

Accordingly, traditional restroom advertising companies solicit other organizations to participate in advertising campaigns that consist of several ads being placed in loosely targeted settings, with loosely targeted audiences based on rough metrics such as geography. Additionally, small companies, including small, local companies also purchase restroom advertising because of the relatively inexpensive nature of conventional indoor restroom advertising. Traditional business models for restroom advertising involve charging advertisers in the approximate range of $30-$190 per restroom space per month. Such revenues are typically divided between the owner or operator of the establishment in which the advertisements are placed and the advertising marketer. I.e. a relatively small percentage of the advertising revenues is typically paid to the hosting establishment for the use of the restroom advertisement space.

Additionally, marketing restroom advertising is a time-consuming and tedious endeavor because small or large companies who may perceive advantages in advertising to a rough demographic must be individually contacted in order to market the advertising. The relatively small fees charged for the advertising and the correspondingly resource-intensive marketing combine to make traditional restroom advertising a low-margin endeavor. Nevertheless, restroom advertising is a potentially powerful medium for reaching consumers of particular products and services. Accordingly, there is a need for methods and systems of marketing indoor restroom advertising in a more directed manner to generate greater advertising revenue.

### SUMMARY

According to various embodiments, the present teachings can provide processes useful in marketing exhibitor-based convention restroom advertising. In so doing, the present teachings increase the profitability of restroom advertising business practices, while streamlining the advertising sales and marketing processes associated with restroom advertising marketing.

The advantages seen through this form of advertising are: (i) the identification of a target demographic by gender, where the audience is already participating in an event such as a convention, which indicates that the participant is presently interested in the subject matter of the advertising; (ii) one-on-one session with the audience; and (iii) a period of approximately one to three minutes to have the complete attention of the viewer.

Consistent with the present teachings, the disclosed methods and systems take the indoor-restroom advertising medium to new levels of profitability by allowing advertiser/exhibitors to gain high levels of participant advertisement retention from the indoor-restroom advertising medium. This, in turn, provides for greater potential revenues for advertising marketers while, at the same time, streamlining the advertisement marketing process.

The advantages of the present teaching can be realized by applying indoor restroom advertising, for example, to the convention center setting and allowing exhibitors to compete with one another for the right to advertise in the ad space of the convention center restrooms. The corresponding increase in efficiency and profitability comes into being when the burdensome task of soliciting outside companies to advertise in the restroom spaces is removed from the marketing process. In the present inventive business model, the marketing processes are focused allowing exhibitors to advertise in the restroom spaces during the period of the convention or exhibition. In an exemplary embodiment, for the use of the restroom facilities, the convention center is rewarded by commission payments, provided, for example, on a quarterly basis, the amount and timing of such commissions being subject to negotiation with the convention center administrator or other party for an established term or potentially on a case-by-case basis. Accordingly, the present teachings create tremendous opportunities for exhibitors. Because the tremendously valuable space is limited, thus allowing only three to five percent (3%-5%) of the exhibitors to participate in the conference restroom advertising, there will frequently be intense competition between the exhibitors for the advertising spaces. And the increased value to the advertising marketer is created by this competition between exhibitors and due to the increase in turnover and rotation of the advertising as the subject matter of conventions or exhibits as well as the identity of the exhibitors changes with each new convention or exhibit.

For example, in some convention centers, each week a different industry association, society, or organization hosts a featured tradeshow, convention, or exhibition. The members of the hosting organization are typically representatives of companies or organizations or individuals who otherwise pay dues to belong to a particular organization or industry group.

Organizational members typically have an affiliation, interest, or relation to the featured tradeshow. The convention halls are sometimes used to host exhibitions that allow the member companies to display, market, advertise or sell their products and/or services. Exhibiting companies have typically have large budgets dedicated to these types of events. It is a gathering of the respective industries' best, biggest, newest and/or most ambitious companies.

A typical number of exhibitors at a professional tradeshow ranges from between approximately 500 to approximately 800 exhibiting companies and has approximately 5,000-80,000 professional attendees. This creates a natural pool of competition between the various exhibitors. Each desires to have the newest and most effective marketing and advertising campaign. The marketing and advertising compliments the company's investment in time, money, people, products and services for the tradeshow, convention, or exhibition.

The advertising and marketing competition created by the pool of exhibiting companies streamlines and potentially eliminates the most tedious and resource intensive part of marketing indoor advertising, namely soliciting the advertisers to advertise on the indoor restroom advertisements. The present teachings allow for the competition between exhibitors to streamline the advertiser solicitation process and to correspondingly increase the potential revenue associated with the advertising.

Attendees of a particular event are highly likely to very closely fit the target audience of advertisers, because the attendees have chosen to attend the event based on their interest in the subject matter of the event. During the course of the event many if not most of the attendees will use the restroom facilities. Accordingly, because of the competition between advertisers and the important value of essentially guaranteed time with as much as a 100% target audience, a daily premium may be charged to advertising exhibitors for the privilege of reaching its target audience in this way.

Moreover, event center (e.g. convention center) owners and/or operators stand to benefit from significant advantages associated with the present teachings. Specifically, the event operators can gain a significant new source of revenue. Second they are able to better satisfy the organizations that contract to use the convention center. Third, they benefit from the improved aesthetics of the restroom facilities.

Accordingly, the present teachings have several advantages. First, advertisers pay a higher fee for a shorter period of time. The advertisers, however, receive extremely high target-audience percentages, and are allowed approximately one to three minutes of uninterrupted time with each person viewing an advertisement.

It is understood that while various embodiments are disclosed in connection with exemplary event centers, such as convention centers, other venues with similarly high percentages of target audiences can benefit from the present teaching without departing from the scope of the present invention. Such venues include schools, universities, certain office environments, sporting events, and auto and boat shows and any type of event with concentrated numbers of attendees who may have the opportunity top visit the restroom while attending an event. Accordingly, it is understood that both the foregoing general description and the following detailed description are exemplary and explanatory only and are not restrictive of the invention as claimed.

The accompanying drawings, which are incorporated in and constitute a part of this specification, illustrate some embodiments of the invention, and together with the description serve to explain the principles of the invention.

### BRIEF DESCRIPTION OF THE DRAWINGS

FIG. 1 illustrates a representative marketing process diagram according to various embodiments of the present teachings; and

FIG. 2 illustrates a representative advertising system according to various embodiments consistent with the present teachings.

### DESCRIPTION OF VARIOUS EMBODIMENTS

Reference will now be made in detail to some embodiments of the invention, examples of which are illustrated in the accompanying drawings. Wherever possible, the same reference numbers are used throughout the drawings to refer to the same or like parts.

The term “indoor restroom advertising” as used herein refers to printed or machine rendered or generated images and indicia, including textual information and other audio-visual information, used to explain or promote a particular advertiser's products, services, or generalized message.

The term “event operator” as used herein refers to an owner or operator of an event center, such as a convention center or a convention management company.

The term “event advertisement engagement” as used herein refers to arrangements made with an event operator as defined immediately above.

The term “event exhibitor” as used herein refers to a participant in an event such as an exhibitor at a trade show or convention, however, as used herein “event exhibitor” also includes any advertiser who wishes to take part in an event by promoting its products in connection with the event.

The term “event exhibitor identifier” as used herein refers to identifying information associated with an event exhibitor.

The term “event exhibitor descriptor” as used herein refers to descriptive information regarding and/or associated with an event exhibitor.

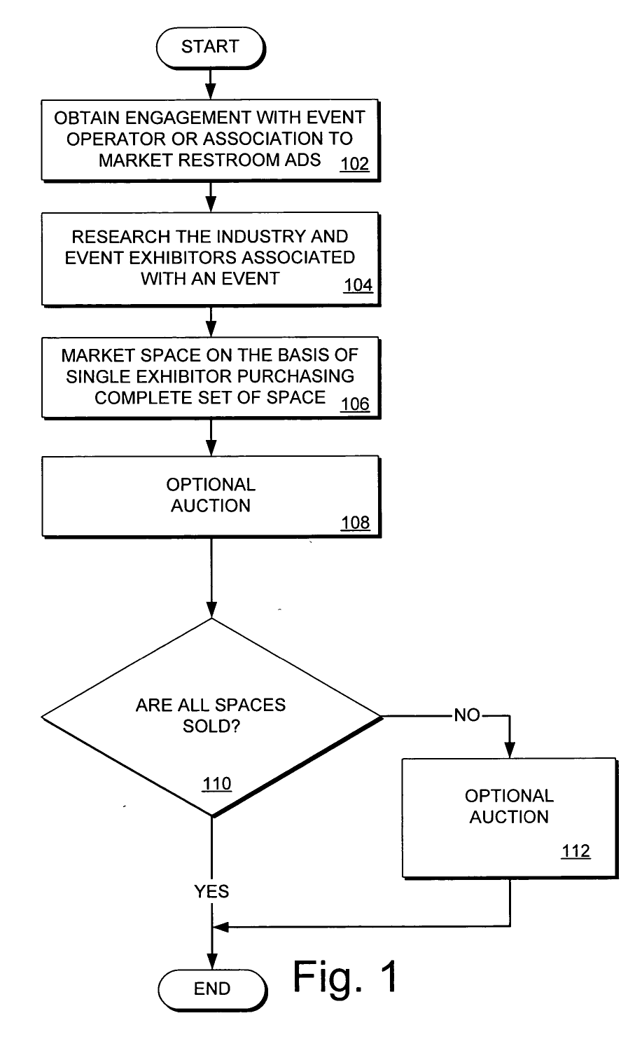

FIG. 1 illustrates a representative marketing process diagram according to various embodiments of the present teachings. According to various embodiments, marketing methods are initiated by making arrangements with an event operator to market indoor restroom advertising in connection with a particular event center (stage 102). In various embodiments, an event center is owned by a city or municipality, such as in the instance of a municipal convention center being owned by a city. Further, an event operator typically operates a particular convention center on behalf of the municipality or private party that owns the convention center. In various embodiments, marketing contact is initiated through the municipality, which has the advantage of enabling the marketer to secure the support of the municipality, which stands to benefit from increased revenue from the convention center. In such embodiments, a portion of the revenue generated in connection with restroom advertising is paid to the city or municipality that owns the convention center. Securing the support of the convention center owner can facilitate the process of securing an engagement with convention center administrators to allow the marketer to market its indoor restroom advertising. In various other embodiments, the convention center bureau is contacted directly in order to establish a relationship with the operator of the convention center.

In yet another set of various alternative embodiments, arrangements can be made with associations to provide indoor restroom advertising for conferences operated or sponsored by the associations. Further, even if a particular association does not have the authority to grant the marketer the ability to provide the advertising services in connection with a particular convention center, if the association becomes enthusiastic about the marketer's services, the association can use its ability to bring its convention to different convention center venues to encourage a convention center to enter into an agreement with the marketer for the marketer to provide its indoor restroom advertising services. In various embodiments, the associations are provided with a portion of the proceeds generated from the advertising services provided in connection with the association's event.

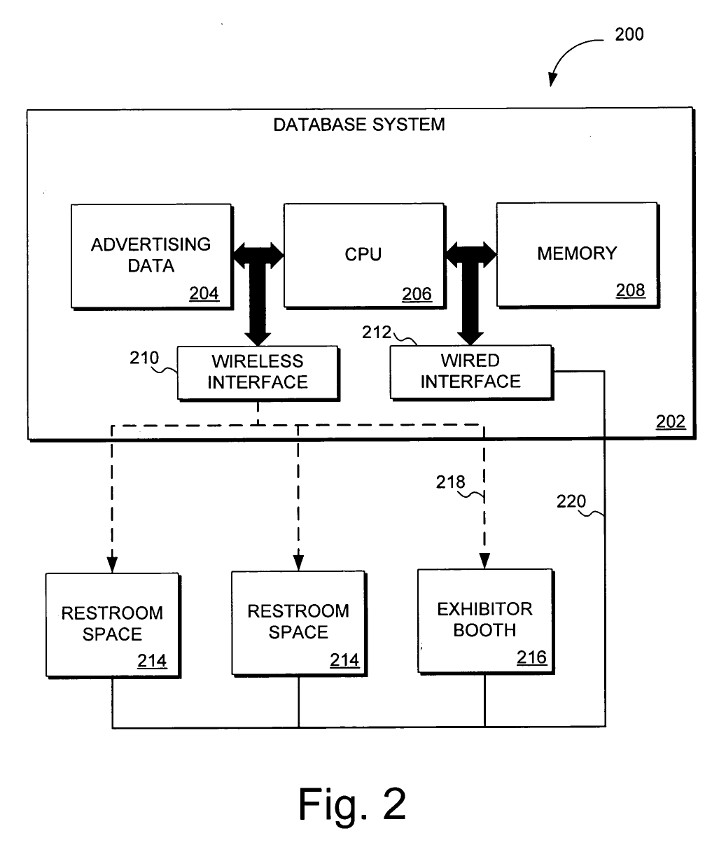

Next, at stage 104 the marketer obtains information regarding the exhibitors who will be exhibiting at a particular event. Such research can include general industry research and generally will include an identification or a list of the exhibitors who will be exhibiting at a particular event. Information regarding the exhibitors can be stored in a database such as the advertising database 204 illustrated in FIG. 2. As more fully set forth below, past information regarding advertising content and placement as it correlates to statistics, such as booth visits, can be associated with prospective exhibitor advertisers in order to promote or price the indoor restroom advertisements. For example, if it has been observed that proximity to a booth draws additional booth visits for a computer system exhibitor when the exhibitor's advertisement is provided near the end (or beginning) of a convention, then this information can be provided in marketing materials to encourage the exhibitor to purchase the space in a restroom location nearest the exhibitor's booth.

In various exemplary embodiments, it is preferable for each of the spaces in a particular restroom to present a unified advertising message. Accordingly, in these various embodiments, an attempt is made to sell each of the spaces in each restroom to a single advertiser. Alternatively, rather than marketing and selling each space in a particular restroom to a single advertiser for the entire convention, restroom advertisement time slots are established and a single advertiser's advertisements are displayed for that time slot. Examples of advertising time slots are as follows. First, an advertiser may wish to purchase the advertising on the second day of a convention, when for example, the greatest number of attendees are expected to be at the convention. Additionally, shorter time slots can be allocated, for example, so that a particular advertiser could obtain a premium-priced time slot in the restrooms during a break in a conference, during a time-out or at half-time of a sporting event, between lectures, or after a keynote lecture. Additionally, portions of a particular restroom can be assigned to particular advertisers. In an embodiment, consistency is maintained when portions of a restroom are assigned to a particular advertiser, so that, for example, if two advertisers have purchased spaces in a restroom each of the advertisers' advertisements are segregated from the other advertiser's to maintain a cohesive message for each advertiser. Alternatively, advertisements from various advertisers can be interspersed.

In various embodiments, optional auctions are employed separately from or in connection with the exhibitor registration process. Accordingly, because of the natural competition between exhibitors to obtain the prime restroom advertising spaces and/or time slots, the exhibitors will be willing to bid against each other for the rights to advertise in a particular restroom location and/or during a particular time slot. It is understood to persons of ordinary skill in the art that various known forms of forward and reverse auction technologies can be used to auction advertising spaces consistent with the present teachings.

In various embodiments, the marketing process is automated in connection with a general purpose computer to further streamline the marketing process. In such various embodiments, the computer-implemented marketing process determines whether all restroom spaces are sold for each of the time slots, if appropriate (stage 110). If it is determined that all spaces are sold, the process terminates, and reports or data sets regarding the advertising are produced. Such reports and data-sets include financial data regarding the advertising, including billing information, which can be used to generate paper bills or statements to be sent to advertisers. Alternatively, electronic billing data is transmitted electronically to advertisers. In an embodiment, the auction process includes payment steps, whereby advertisers provide payment information during and/or at the completion of the auction process. If at stage 110, it is determined that not all restroom advertising spaces have been sold, then further optional auctions can be carried out (stage 112). Alternatively to the optional auction stages 102 and 112, materials can be provided to exhibitors in connection with their registration materials so that the exhibitors can call or go on-line to purchase their advertising slots. Under such an arrangement, advertising could be sold, for example, on a first-call-first-served basis.

FIG. 2 illustrates a representative advertising system according to various embodiments consistent with the present teachings. As set forth above, indoor restroom advertising can include graphical displays and textual materials that are either printed or rendered automatically, such as for example, by way of an electronically controlled LCD display. In the case of remotely operated automatically rendered advertising, an automated restroom advertising network 200 can be employed to automatically place the proper advertisements in the proper locations during the proper time slot. This can be carried out in connection with database system 202, which it is understood can be implemented on a single general purpose computer system including a CPU 206, advertising data 204, memory 208, and interfaces such as wireless interface 210 and wired interface 212. It is understood that database system 202 can also be distributed across a group of specific and general purpose computers employing, for example multi-tier database architectures. Moreover, in various alternative embodiments, electronic, automatic toilet or urinal flushing devices (not shown) are incorporated into the restroom advertising network to be used as inputs for displaying the targeted advertising. For example, through the use of autoflush technology, an advertisement can be changed at each flush, thereby changing the displayed advertisement for each user of a particular toilet or urinal.

In various embodiments, the restroom advertising network 200 operates in connection with data collected and organized during an automated auction process as set forth in connection with FIG. 1. In such various embodiments, a correlated list of restroom spaces and time slots is obtained from the auction process and then associated with actual advertising content, i.e. photographs, artwork, text, and optional audio-visual information. In an embodiment, the advertising data 204 is used to display and/or otherwise output the advertising content at restroom spaces 214. The advertising content can be transmitted using wireless and/or wired interfaces 210 and 212 over communications media 218 and 220, the dashed lines of medium 218 indicating the use of a wireless technology and the solid line of media 220 indicating a wired technology. It is understood that various known or future developed wireless or wired communication media and protocols can be employed without departing from the scope of the present teachings.

In other various embodiments, information is transmitted from the database system 202 to inform technicians or custodians, who may be employed by the advertising marketer or by the convention center operator or owner to instruct the technician or custodian which advertising content to insert into or apply to each restroom advertising space. In an embodiment, a printed work order is generated which identifies advertising content by a product number and associates (in writing) the content with particular restroom spaces on a daily or time-slot basis, to facilitate the installation of the advertising content.

According to various embodiments, information regarding the impact of particular advertising content is collected for future use in marketing or pricing indoor restroom advertisements. In such various embodiments, data-collection-systems (not shown) at an exhibitor booth 216 are operable to provide time-stamped information regarding participation at particular exhibitor booths. Exhibition booth data collection systems are known and can include hand-written logs of attendees visits to booths and attendee ID card swipes for performing various activities at a booth such as completing a survey, actually making a purchase, or providing contact information. In this way, success at exhibitor booths can be correlated with advertising content and placement, including location and time-slot. Such advertising correlation information can be used in future restroom advertising marketing.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for providing indoor restroom advertising in connection with a scheduled event, the method comprising:
establishing an event advertisement engagement with an event operator of an event facility in order to obtain permission to market the indoor restroom advertising in connection with the scheduled event;
receiving a set of event exhibitor identifiers for event exhibitors participating in the scheduled event;
providing information regarding the indoor restroom advertising to the event exhibitors;
receiving requests to purchase targeted indoor restroom advertising from the event exhibitors for at least a portion of the scheduled event; and
providing the targeted indoor restroom advertising during the specified portions of the scheduled event in restrooms at the event facility.

2. The method as set forth in claim 1, wherein the scheduled event is a convention.

3. The method as set forth in claim 2, wherein the event exhibitor is a convention exhibitor.

4. The method as set forth in claim 1, wherein the scheduled event is an industry conference.

5. The method as set forth in claim 1, wherein the scheduled event is a trade show.

6. The method as set forth in claim 1, wherein the event exhibitor identifiers comprise participant name, contact information, and market target information.

7. The method as set forth in claim 1, wherein the step of receiving requests comprises receiving bids to purchase the targeted indoor restroom advertising using a forward auction format.

8. The method as set forth in claim 1, wherein the step of receiving requests comprises receiving bids to purchase the targeted indoor restroom advertising using a reverse auction format.

9. The method as set forth in claim 1 further comprising: identifying selected event exhibitor identifiers associated with targeted event exhibitors in the set of event exhibitors based on a targeted event exhibitor descriptor in the set of event exhibitor descriptors;
accessing stored statistical information regarding past advertising performance; and
offering a targeted indoor restroom advertising package to the targeted event exhibitors based on the event exhibitor identifiers, the event exhibitor descriptors, and the stored statistical information regarding past advertising performance.

10. The method as set forth in claim 1, wherein the event facility is a convention center.

11. An automated system for marketing and providing indoor restroom advertising in connection with a scheduled event at an event facility, the method comprising:
means for receiving purchase requests from a set of event exhibitors for indoor restroom advertising;
means for selectively receiving a set of event exhibitor identifiers and a corresponding set of advertising content identifiers, the event exhibitor identifiers associated with the set of event exhibitors, the selectively receiving based on the purchasing requests;
means for generating outputs correlating the set of event exhibitor identifiers, and the advertising content identifiers with event restroom space identifiers to facilitate provision of advertising content within restrooms within the event facility.

12. The automated system of claim 11, wherein the means for receiving purchase events is a computer-implemented on-line forward or reverse auction.

13. The automated system of claim 11, wherein the means for receiving purchase requests is a computer implemented on-line forward auction.

14. The automated system of claim 11, wherein the means for generating outputs further comprises:
means for accessing the advertising content in machine readable format; and
means for transmitting the advertising content to means for displaying the advertising content in the restroom facilities.

15. The automated system of claim 11, further comprising:
means for providing the advertising content during particular time slots.

16. The automated system of claim 15, further comprising:
means for receiving and storing advertising success information and associating the advertising success information with the location and time-slot information associated with the advertising content.

17. A method for providing indoor restroom advertising in connection with a scheduled event at an event facility, the method comprising:
receiving and storing past advertising success information based on information obtained from attendees of past events during a period when past indoor restroom advertising was being displayed in restrooms of past event facilities;
receiving a set of event exhibitor identifiers and a set of event exhibitor descriptors for event exhibitors participating in the scheduled event;
providing information regarding the indoor restroom advertising to the event exhibitors including information derived from the advertising success information;
receiving requests to purchase targeted indoor restroom advertising from the event exhibitors for at least a portion of the scheduled event; and
determining pricing for the targeted indoor restroom advertising based upon the event exhibitor descriptors and the advertising success information.
